(19) United States
(12) Patent Application Publication
(10) Pub. No.: US 2026/0254580 A1
(43) Pub. Date: Aug. 27, 2026

(54) HETEROGENEOUS CSI REPORTING FOR CRI-BASED CSI FRAMEWORK

(71) Applicant: Samsung Electronics Co., Ltd., Suwon-si (KR)

(72) Inventors: Rui Huang, Toronto (CA); R A Nadisanka Perera Rupasinghe, McKinney, TX (US); Rajesh Kumar Mishra, Dallas, TX (US); Xiaochuan Ma, Hillsborough, NJ (US); Yang Li, Plano, TX (US)

(21) Appl. No.: 19/538,676

(22) Filed: Feb. 12, 2026

Related U.S. Application Data
(60) Provisional application No. 63/763,091, filed on Feb. 25, 2025.

(51) Int. Cl. H04L 5/00

(52) U.S. Cl. CPC H04L 5/0048

(57) ABSTRACT

Methods and apparatuses for a heterogeneous CSI reporting for a CRI-based CSI framework in wireless communication systems. The method of a BS comprises: receiving, from a UE, CSI feedback including heterogeneous CSI feedback information; identifying virtualization weights using a CSI BF neural network functional entity comprising a MLP functional entity; selecting, based on the virtualization weights, CSI-RS resources for the CSI feedback; and reconstructing, based on the virtualization weights and the heterogeneous CSI feedback information, a channel using a CSI fusion network functional entity, wherein the heterogeneous CSI feedback information includes different CSI types each of which is configured for different CSI-RS resources.

### CROSS-REFERENCE TO RELATED APPLICATIONS AND CLAIM OF PRIORITY

The present application claims priority to U.S. Provisional Patent Application No. 63/763,091, filed on Feb. 25, 2025. The contents of the above-identified patent documents are incorporated herein by reference.

### TECHNICAL FIELD

The present disclosure relates generally to wireless communication systems and, more specifically, the present disclosure relates to a heterogeneous channel state information (CSI) reporting for a CSI-reference signal resource indication (CRI)-based CSI framework in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a heterogeneous CSI reporting for a CRI-based CSI framework in wireless communication systems.

In one embodiment, a base station (BS) in a wireless communication system is provided. The BS comprises a transceiver configured to receive, from a user equipment (UE), CSI feedback including heterogeneous CSI feedback information. The BS further comprises a processor operably coupled to the transceiver, the processor configured to: identify virtualization weights using a CSI beamforming (BF) neural network functional entity comprising a multilayer perception (MLP) functional entity, select, based on the virtualization weights, CSI reference signal (CSI-RS) resources for the CSI feedback, and reconstruct, based on the virtualization weights and the heterogeneous CSI feedback information, a channel using a CSI fusion network functional entity, wherein the heterogeneous CSI feedback information includes different CSI types each of which is configured for different CSI-RS resources.

In another embodiment, a method of a BS in a wireless communication system is provided. The method of BS comprises: receiving, from a UE, CSI feedback including heterogeneous CSI feedback information; identifying virtualization weights using a CSI BF neural network functional entity comprising an MLP functional entity; selecting, based on the virtualization weights, CSI-RS resources for the CSI feedback; and reconstructing, based on the virtualization weights and the heterogeneous CSI feedback information, a channel using a CSI fusion network functional entity, wherein the heterogeneous CSI feedback information includes different CSI types each of which is configured for different CSI-RS resources.

In yet another embodiment, a UE in a wireless communication system is provided. The UE comprises a processor configured to: select, based on beamformed CSI-RS received from a base station, CSI-RS resources, and generate, based on the CSI-RS resources, heterogeneous CSI feedback information including different CSI types each of which is configured for different CSI-RS resources. The UE further comprises a transceiver operably coupled to the processor, the transceiver configured to transmit, to the base station, CSI feedback including the heterogeneous CSI feedback information, wherein virtualization weights are identified, based on a CSI BF neural network, for the beamformed CSI-RS, and wherein a channel is reconstructed, based a CSI fusion network, based on the virtualization weights and the heterogeneous CSI feedback information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of an enhanced CRI-based CSI-RS framework according to various embodiments of the present disclosure;

FIG. 8 illustrates an example of an MLP functional entities maintained by a gNB to learn beamforming weights F according to various embodiments of the present disclosure;

FIG. 9 illustrates an example of different CSI types associated with different CSI-RS resources according to various embodiments of the present disclosure;

FIG. 10 illustrates an example of a CSI fusion network according to various embodiments of the present disclosure; and

FIG. 11 illustrates a flowchart of a BS method for a heterogeneous CSI reporting for a CRI-based CSI framework according to various embodiments of the present disclosure.

### DETAILED DESCRIPTION

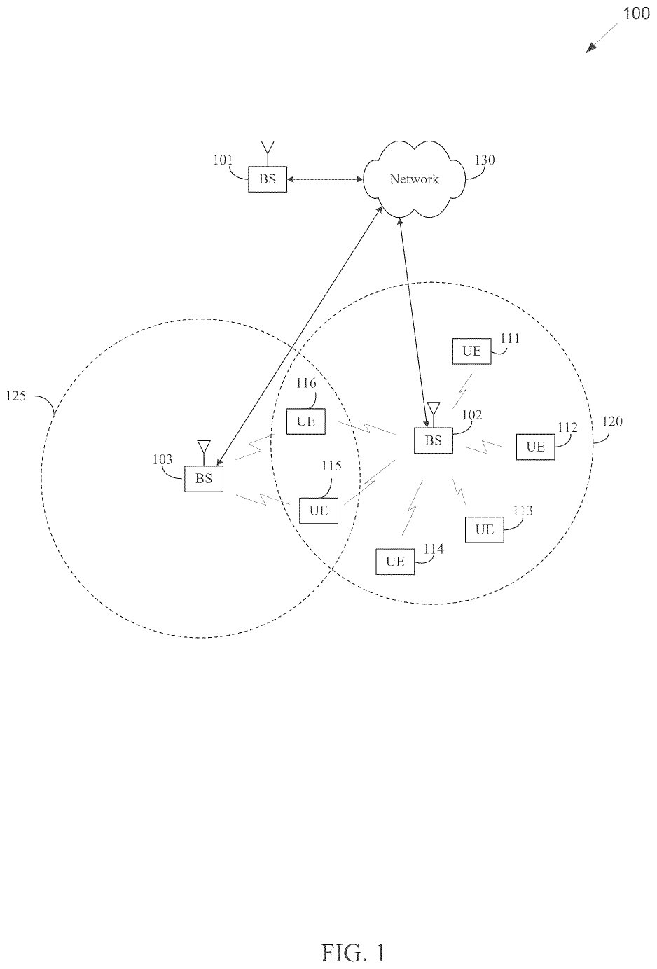

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.211 v16.4.0 , “E-UTRA, Physical channels and modulation”; 3GPP TS 36.212 v16.4.0 , “E-UTRA, Multiplexing and Channel coding”; 3GPP TS 36.213 v16.4.0 , “E-UTRA, Physical Layer Procedures”; 3GPP TS 36.321 v16.3.0 , “E-UTRA, Medium Access Control (MAC) protocol specification”; 3GPP TS 36.331 v16.3.0 , “E-UTRA, Radio Resource Control (RRC) Protocol Specification”; 3GPP TS 38.211 v16.4.0 , “NR, Physical channels and modulation”; 3GPP TS 38.212 v16.4.0 , “NR, Multiplexing and Channel coding”; 3GPP TS 38.213 v16.4.0 , “NR, Physical Layer Procedures for Control”; 3GPP TS 38.214 v16.4.0 , “NR, Physical Layer Procedures for Data”; 3GPP TS 38.215 v16.4.0 , “NR, Physical Layer Measurements”; 3GPP TS 38.321 v16.3.0 , “NR, Medium Access Control (MAC) protocol specification”; and 3GPP TS 38.331 v16.3.1 , “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a heterogeneous CSI reporting for a CRI-based CSI framework, at a gNB 101-103, in wireless communication systems. In certain embodiments, and one or more of the gNBs 101-103 includes circuitry, programing, or a combination thereof, to support a heterogeneous CSI reporting for a CRI-based CSI framework in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

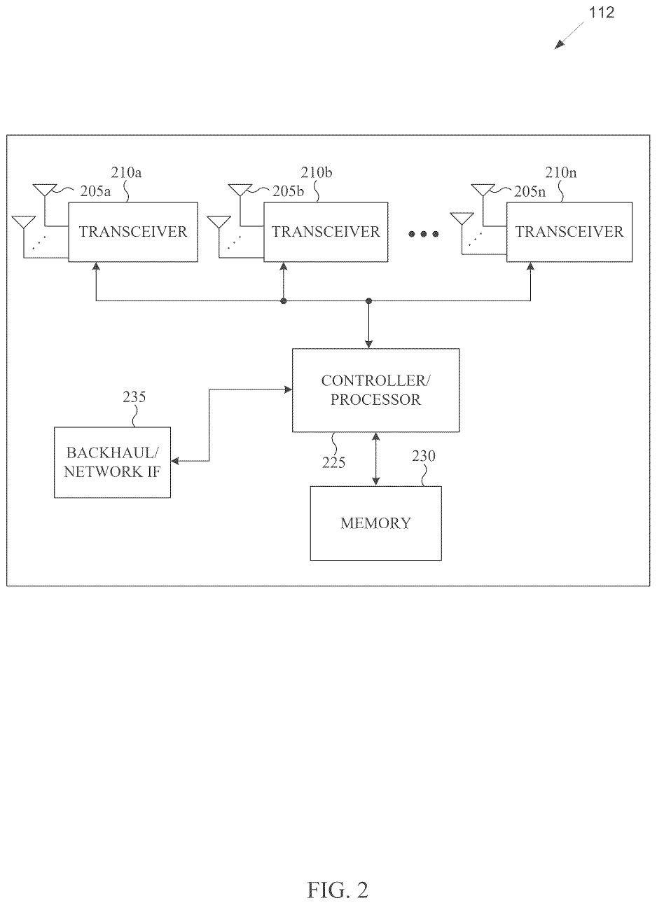

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a heterogeneous CSI reporting for a CRI-based CSI framework in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

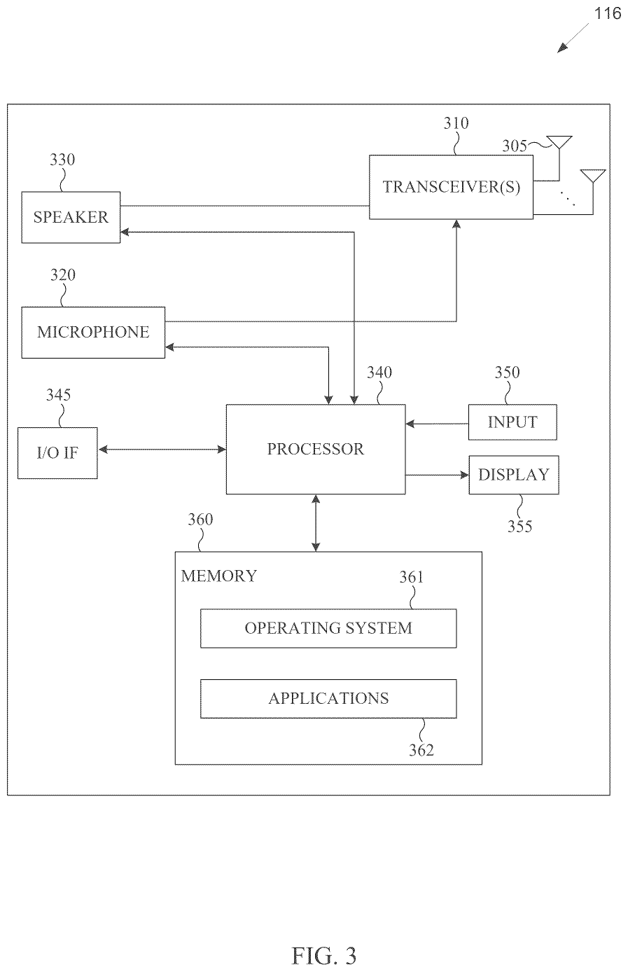

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a heterogeneous CSI reporting for a CRI-based CSI framework, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

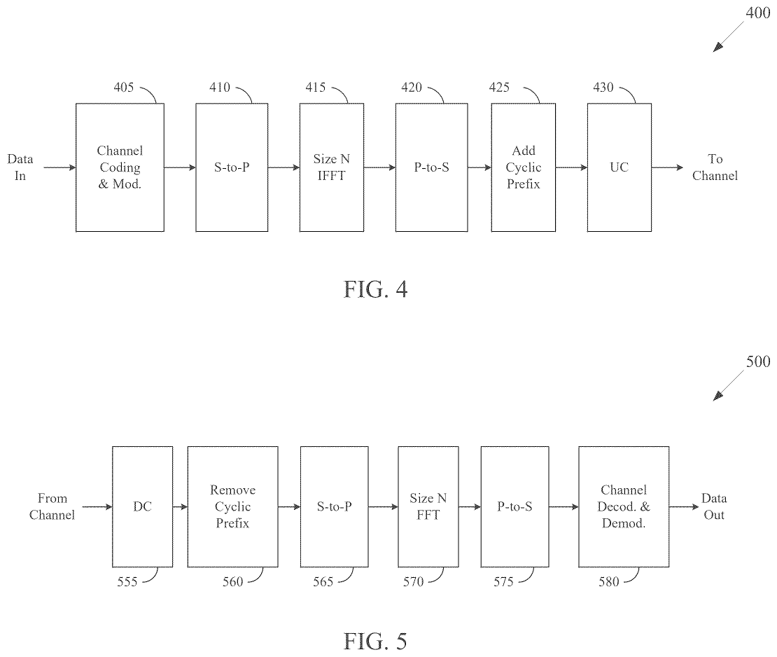

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

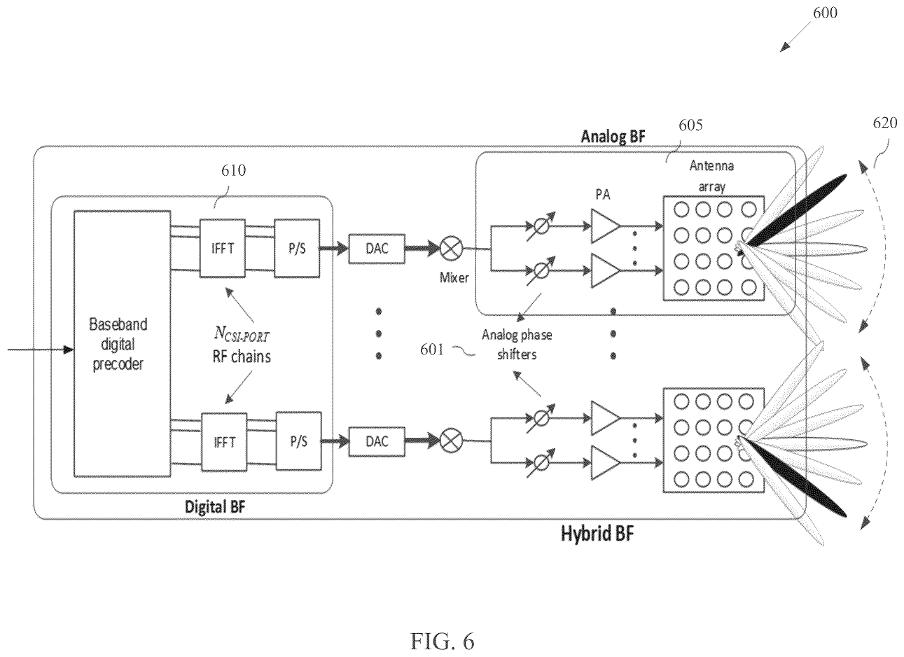

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size for a carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

In 6G communication systems, artificial intelligence (AI) will play a pivotal role. There are many discussions on-going at the moment on how AI can be realized especially in physical (PHY) layer aspects. With advanced AI techniques in the vicinity for 6G.

The present disclosure provides enhancement of a CRI-based CSI framework to better facilitate some advanced AI based solution in 6G.

The present disclosure provides enhancements for a CRI-based CSI framework in 6G communication systems to facilitate some advanced AI-based solutions.

A CRI-based CSI framework in 5G systems mainly targets enhancing PMI performance in cell-edge users. However, there are some issues to be addressed to make the CRI-based CSI framework more robust and resilient. Some examples include a rank recovery, a dynamic switching between beamformed (BF'd) and non BF'd CSI-RS transmission. Further, when extending this solution for 6G systems, further enhancements to the framework are introduced especially to support advanced AI-based solutions. The present disclosure provides enhancements to a CRI-based CSI framework to address aforementioned issues.

Providing a CRI framework including virtualizing one or more CSI-RS resources using one or more virtualization weights learned from a CSI beamforming (BF) neural network, the one or more virtualization weights including one or more pre-defined PMI weights or one or more UE-specific weights.

Generating, at one or more UEs, a heterogenous CSI feedback based on BS configuration information for each of one or more virtualized CSI-RS resources received at the one or more UEs.

Reconstructing, at one or more BSs, a channel via a CSI fusion neural network based on the heterogenous CSI feedback generated at the one or more UEs and the one or more virtualization weights.

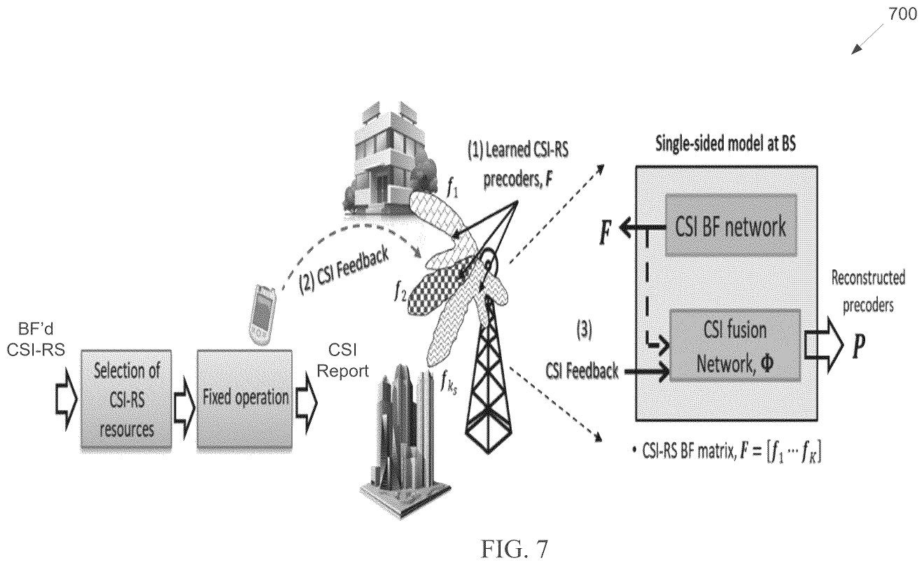

FIG. 7 illustrates an example of an enhanced CRI-based CSI-RS framework 700 according to various embodiments of the present disclosure. An embodiment of the enhanced CRI-based CSI-RS framework 700 shown in FIG. 7 is for illustration only.

FIG. 7 illustrates an overall system operation of the enhanced CRI-based CSI framework as provided in the present disclosure. As can be seen, there are two main components at the gNB side in the provided framework: (i) a CSI-RS beamforming network, and (ii) a CSI fusion network. At the UE, a fixed operation/structure is applied to a selected set of beamformed (BF'd) CSI-RS.

It may be assumed that there are N_{Tx} antenna ports (TXRUs) at the gNB. In particular, the gNB first transmits K_{S} number of BF'd N_{CSI-RS}-port CSI-RSs. In one embodiment, N_{CSI-RS} can be one (single port CSI-RS). In another embodiment, N_{CSI-RS} is smaller than N_{Tx} ports. Note that, K_{S} CSI-RS resources can be time-multiplexed or both time and frequency multiplexed.

In one embodiment, a beamforming applied to each CSI-RS resource can be learned as part of the joint learning process with CSI fusion network.

A single-sided deep neural network (DNN), employing learnable parameters Θ, can be maintained at the gNB to learn the beamforming weights applied to K_{S} number of BF'd N_{CSI-RS}-port CSI-RSs. Let F∈C^{K}_{S}^{×N}_{CSI-RS} denote as such beamforming weights. Then, the beamforming weights F can be learned by the DNN with parameters Θ, based on either explicit or implicit information about the UEs.

In one embodiment, the beamforming weights F can be learned, based on the implicit information reported by the UEs. In one example, such implicit information includes the PMI reported by the UEs. Let Pᵢ denotes the PMI reported by UE i. Then, the beamforming weights for UE i is determined by: F=f_{Θ}(Pᵢ), where f_{Θ}(·) is the function parameterized by the learnable parameters Θ, and can be determined by the specific DNN structure.

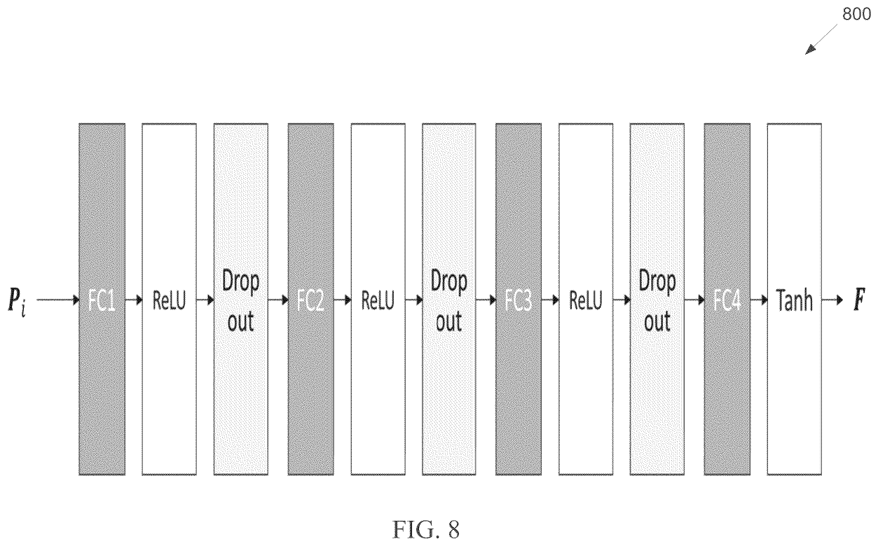

In one example of a DNN structure, a multilayer perception (MLP) functional entity can be employed by the gNB to learn the beamforming weights F based on the reported PMI Pᵢ from the UEs. An example of the MLP functional entity is illustrated in FIG. 8.

FIG. 8 illustrates an example of MLP functional entities 800 maintained by a gNB to learn beamforming weights F according to various embodiments of the present disclosure. An embodiment of the MLP functional entities 800 shown in FIG. 8 is for illustration only.

In particular in this example, the MLP functional entity comprises four fully-connected (FC) layers, three activation functions (ReLU and Tanh), as well as three drop-out layers. The provided methods can be applied to other DNN structures, including but not limited to convolutional neural networks (CNNs) and Transformer networks.

In another embodiment, the beamforming weights F can be learned based on explicit information about the channels of UEs, such as sounding reference signals (SRSs). As illustrated in FIG. 8, the learning based on implicit information is done by replacing the input to the single-sided DNN from UE reported PMI Pᵢ, with explicit information, such as the channel estimated based on SRS of the UE.

Once a UE receives these BF'd CSI-RS transmissions, the UE is higher layer configured to select M (<K_{S}) number of CSI-RS resources for CSI reporting. These selected M CSI-RS resources may subsequently be used to generate CSI feedback. In particular, the UE may follow a pre-defined fixed structure/operation for such CSI generation. The generated CSI may then be shared with a gNB along with the information regarding selected M or (M-Mᵣ) CSI-RS resources.

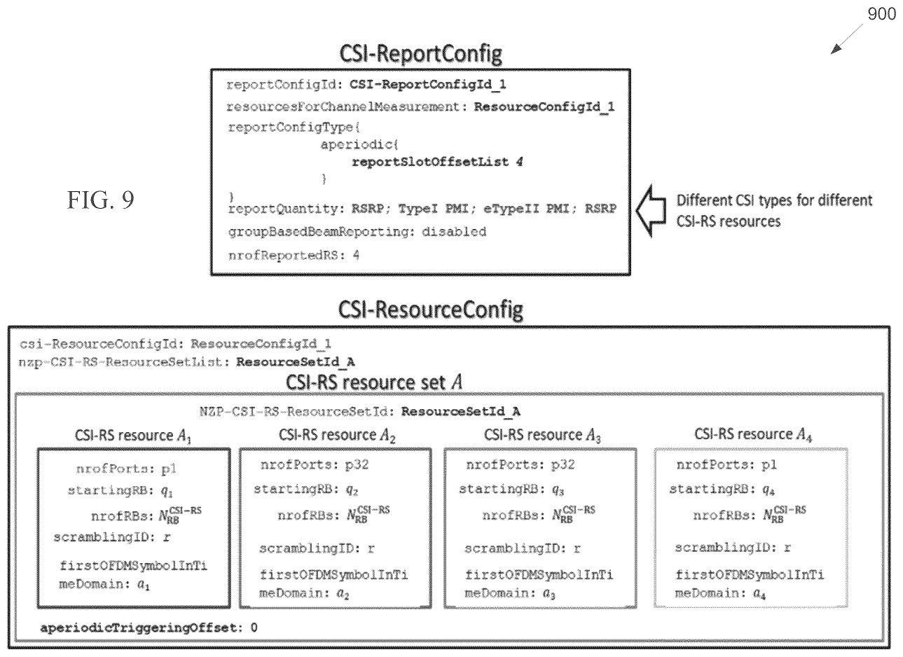

A UE can be higher layer configured to report different CSI types for different BF'd CSI-RS resources. In one embodiment, as illustrated in FIG. 9, different CSI types can be configured for different CSI-RS resources.

FIG. 9 illustrates an example of different CSI types associated with different CSI-RS resources 900 according to various embodiments of the present disclosure. An embodiment of the different CSI types associated with different CSI-RS resources 900 shown in FIG. 9 is for illustration only.

In particular, as illustrated in FIG. 8, a UE can be configured to report reference signal received power (RSRP), TypeI PMI, eTypeII PMI, and RSRP for CSI-RS resources A₁, A₂, A₃, and A₄, respectively.

In another embodiment, a UE can be higher layer configured with possible CSI types for reporting and UE determines which CSI type to be reported for each CSI-RS resource. For an example, “reportQuantity” field in “CSI-ReportConfig” (e.g., as illustrated in FIG. 9) informs the UE possible CSI types are, RSRP, TypeI PMI, eTypeII PMI. Then, the UE selects what to report for each BF'd CSI-RS resource out of those configured. Selected CSI type for each resource may be explicitly reported as well.

In one embodiment, a UE can be higher layer configured to report a certain CSI type for sub-set of BF'd CSI-RS resources. For other CSI-RS resources, the UE may freely select appropriate CSI types based on certain requirements.

Upon receiving the CSI feedback from the UE, a gNB further employs a deep neural network named CSI fusion network to reconstruct the channel. The CSI fusion network takes one or more of the following information as the input(s): (i) the learned virtualization weights F learned by the CSI BF network, (ii) the heterogenous CSI feedback from the UE, as configured by the gNB, and/or (iii) and outputs the reconstructed CSI of the UE.

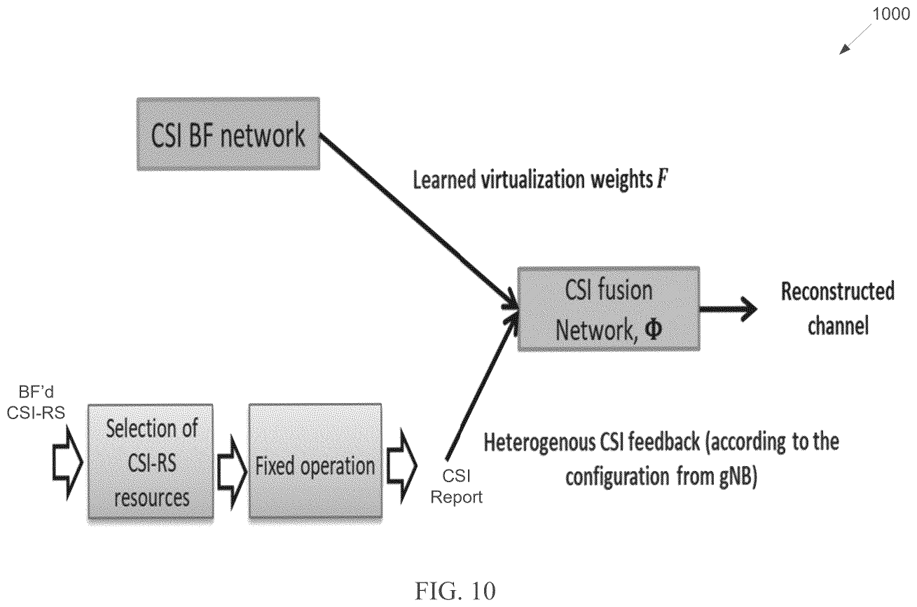

FIG. 10 illustrates an example of a CSI fusion network 1000 according to various embodiments of the present disclosure. An embodiment of the CSI fusion network 1000 shown in FIG. 10 is for illustration only.

In some embodiments, a UE can be higher layer configured to report different CSI types for different beamformed CSI-RS resources.

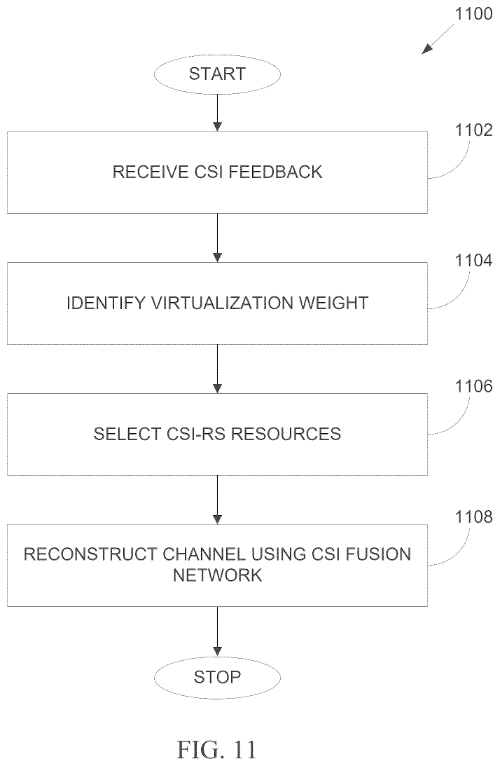

FIG. 11 illustrates a flowchart of a BS method 1100 for a heterogeneous CSI reporting for a CRI-based CSI framework according to various embodiments of the present disclosure. The method 1100 may be performed by a BS (e.g., 101-103 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. In step 1102, a BS receives, from a UE, CSI feedback including heterogeneous CSI feedback information.

Subsequently, in step 1104, the BS identifies virtualization weights using a CSI BF neural network functional entity comprising a MLP functional entity.

Next, in step 1106, the BS selects, based on the virtualization weights, CSI-RS resources for the CSI feedback.

Finally, in step 1108, the BS reconstructs, based on the virtualization weights and the heterogeneous CSI feedback information, a channel using a CSI fusion network functional entity. In this step, the heterogeneous CSI feedback information includes different CSI types each of which is configured for different CSI-RS resources.

In one embodiment, the BS further comprises virtualizing, based on a CRI network functional entity, the CSI-RS resources using the virtualization weights, wherein the CSI-RS resources are virtualized based on a site-specific operation or a predefined operation using a leaning machine model.

In one embodiment, the virtualization weights include at least one predefined PMI or at least one UE-specific weight.

In one embodiment, the BS accumulates, based on a resolution or an amount of overhead of at least one CSI feedback, the at least one CSI feedback for reconstructing the channel.

In one embodiment, the BS transmits a signal including information used to configure the different CSI types included in the heterogeneous CSI feedback information.

In one embodiment, the BS identifies PMI-specific virtualization weights via the CSI BF network functional entity and sends the identified PMI-specific virtualization weights to the CSI fusion network functional entity.

In one embodiment, the CSI-RS is selected into an individual CSI-RS or a group of CSI-RSs.

In one embodiment, the BS identifies rank and precoders for a beamforming operation over the reconstructed channel.

In one embodiment, the different CSI-RS resources are used for at least one of an RSRP reporting, a Type I PMI, or an eType II PMI.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the claims appended. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), channel state information (CSI) feedback including heterogeneous CSI feedback information; and
a processor operably coupled to the transceiver, the processor configured to:
identify virtualization weights using a CSI beamforming (BF) neural network functional entity comprising a multilayer perception (MLP) functional entity,
select, based on the virtualization weights, CSI reference signal (CSI-RS) resources for the CSI feedback, and
reconstruct, based on the virtualization weights and the heterogeneous CSI feedback information, a channel using a CSI fusion network functional entity,
wherein the heterogeneous CSI feedback information includes different CSI types each of which is configured for different CSI-RS resources.

2. The BS of claim 1, wherein:
the processor is further configured to virtualize, based on a CSI-RS resource indicator (CRI) network functional entity, the CSI-RS resources using the virtualization weights, and
the CSI-RS resources are virtualized based on a site-specific operation or a predefined operation using a leaning machine model.

3. The BS of claim 1, wherein the virtualization weights include at least one predefined precoding matrix indicator (PMI) or at least one UE-specific weight.

4. The BS of claim 1, wherein the processor is further configured to accumulate, based on a resolution or an amount of overhead of at least one CSI feedback, the at least one CSI feedback for reconstructing the channel.

5. The BS of claim 1, wherein the transceiver is further configured to transmit a signal including information used to configure the different CSI types included in the heterogeneous CSI feedback information.

6. The BS of claim 1, wherein the processor is further configured to:
identify PMI-specific virtualization weights via the CSI BF network functional entity; and
send the identified PMI-specific virtualization weights to the CSI fusion network functional entity.

7. The BS of claim 1, wherein the CSI-RS is selected into an individual CSI-RS or a group of CSI-RSs.

8. The BS of claim 1, wherein the processor is further configured to identify rank and precoders for a beamforming operation over the reconstructed channel.

9. The BS of claim 1, wherein the different CSI-RS resources are used for at least one of a reference signal received power (RSRP) reporting, a Type I precoding matrix indicator (PMI), or an eType II PMI.

10. A method of a base station (BS) in a wireless communication system, the method comprising:
receiving, from a user equipment (UE), channel state information (CSI) feedback including heterogeneous CSI feedback information;
identifying virtualization weights using a CSI beamforming (BF) neural network functional entity comprising a multilayer perception (MLP) functional entity;
selecting, based on the virtualization weights, CSI-RS resources for the CSI feedback; and
reconstructing, based on the virtualization weights and the heterogeneous CSI feedback information, a channel using a CSI fusion network functional entity,
wherein the heterogeneous CSI feedback information includes different CSI types each of which is configured for different CSI-RS resources.

11. The method of claim 10, further comprising virtualizing, based on a CSI-RS resource indicator (CRI) network functional entity, the CSI-RS resources using the virtualization weights, wherein the CSI-RS resources are virtualized based on a site-specific operation or a predefined operation using a leaning machine model.

12. The method of claim 10, wherein the virtualization weights include at least one predefined precoding matrix indicator (PMI) or at least one UE-specific weight.

13. The method of claim 10, further comprising accumulating, based on a resolution or an amount of overhead of at least one CSI feedback, the at least one CSI feedback for reconstructing the channel.

14. The method of claim 10, further comprising transmitting a signal including information used to configure the different CSI types included in the heterogeneous CSI feedback information.

15. The method of claim 10, further comprising:
identifying PMI-specific virtualization weights via the CSI BF network functional entity; and
sending the identified PMI-specific virtualization weights to the CSI fusion network functional entity.

16. The method of claim 10, wherein the CSI-RS is selected into an individual CSI-RS or a group of CSI-RSs.

17. The method of claim 10, further comprising identifying rank and precoders for a beamforming operation over the reconstructed channel.

18. The method of claim 10, wherein the different CSI-RS resources are used for at least one of a reference signal received power (RSRP) reporting, a Type I precoding matrix indicator (PMI), or an eType II PMI.

19. A user equipment (UE) in a wireless communication system, the UE comprising:
a processor configured to:
select, based on beamformed channel state information (CSI) reference signal (CSI-RS) received from a base station, CSI-RS resources, and
generate, based on the CSI-RS resources, heterogeneous CSI feedback information including different CSI types each of which is configured for different CSI-RS resources; and
a transceiver operably coupled to the processor, the transceiver configured to transmit, to the base station, CSI feedback including the heterogeneous CSI feedback information,
wherein virtualization weights are identified, based on a CSI beamforming (BF) neural network, for the beamformed CSI-RS, and
wherein a channel is reconstructed, based a CSI fusion network, based on the virtualization weights and the heterogeneous CSI feedback information.

20. The UE of claim 19, wherein the transceiver is further configured to receive a signal including information used to configure the different CSI types included in the heterogeneous CSI feedback information.
